(19) United States
(12) Patent Application Publication
(10) Pub. No.: US 2012/0251434 A1
(43) Pub. Date: Oct. 4, 2012

(54) METHOD AND REACTOR FOR TREATING BULK MATERIAL CONTAINING CARBON

(76) Inventors: Hubert Jaeger, Zusamaltheim (DE); Johann Daimer, Morfelden-Walldorf (DE)

(21) Appl. No.: 13/497,610

(22) PCT Filed: Sep. 23, 2010
(86) PCT No.: PCT/EP2010/064051

§ 371 Date: May 31, 2012

(30) Foreign Application Priority Data
Sep. 23, 2010 (DE) 10 2009 042 449.0

(51) Int. Cl. C01B 31/02; B01J 19/00

(52) U.S. Cl. 423/461; 422/184.1; 422/162

(57) ABSTRACT

The invention relates to a method for treating bulk material which contains carbon and impurities. According to the invention, bulk material is directly heated inductively inside a reactor.

The invention relates to a method for refining bulk material which contains impurities and carbon and to a reactor for carrying out the method.

Molded parts containing carbon, such as furnace lining bricks, are used for high temperature resistant furnace lining or as cathodes. Cathodes made from amorphous carbon, amorphous carbon with added graphite or from graphite in electrolysis cells (with electrolysis cells also being called “pots”) are used for the electrolytic smelting of aluminum, for example. At the end of the service life of the cathodes, they have fluorine compounds and cyanide compounds as well as aluminum and/or aluminum compounds as impurities. Due to stricter legal requirements, such spent carbon lining, also called “spent potlining (SPL)”, may not be stored on dump sites, used as fuel or reused as a resource without treatment.

A method for refining SPL is described, for example, in the US patent specification U.S. Pat. No. 5,164,174. In this respect, a conventional rotary kiln is used which is heated directly by a gas flame. At least a large part of the carbon is converted into carbon monoxide and carbon dioxide in an oxidizing atmosphere. The carbon is thereby spent and furthermore large quantities of gases arise which make necessary large dimensions of the rotary kiln and of the subsequent gas purification stages.

A closed electrothermic smelting furnace is used in U.S. Pat. No. 5,286,274. The dimensions of the apparatus, which are configured too large for at least individual smelters and which require a widely configured logistics network, are disadvantageous here. In this method, a considerable portion of the carbon is directly oxidized to CO₂ and is thus removed from further exploitation.

It is the object of the present invention to provide a method with which spent potlining and bricks containing carbon can be refined with the aid of a small-volume reactor.

The object is satisfied by all features of the method in accordance with claim 1. Further developments of the method in accordance with the invention are set forth in the dependent claims 2 to 21.

It is material to the invention that bulk material containing impurities and carbon is inductively and directly heated in a reactor for its refining. A direct inductive heating is possible in that the bulk material has such an electric conductivity that frequencies of an induction heating couple into the bulk material and heat it directly without a coupling into an additional medium being necessary. The method in accordance with the invention has the advantage that large quantities of combustion gases which make necessary a correspondingly large-volume reactor are not caused by combustion reactions. Furthermore, a reactor wall does not have to be heated, which has the consequence of only a small heat loss via the reactor wall and thus a very high energy efficiency of the method.

Refining within the framework of the invention is understood as a treating of bricks containing carbon with which toxic impurities are removed from the bricks and/or are converted into non-toxic compounds, with this treating being carried out to the extent that these bricks can be stored on dump sites, can be used as resources and/or can be used as fuel without any risk to the environment or to people.

The carbon of the bulk material can be present, for example, as amorphous carbon, natural graphite, synthetic graphite or in any other desired form. Only an inductive coupling has to be able to take place.

The bulk material preferably contains at least one bulk material from the group consisting of broken cathodes from an aluminum smelting process, broken anodes, broken carbon linings from a steel smelting oven, from a steel furnace or from another metal smelting furnace, a glass smelting furnace, a ceramics smelting furnace and other bricks containing carbon to be refined.

The impurities can contain at least one impurity from the group consisting of cyanides and soluble fluorides. These impurities accumulate, for example on an electrolytic smelting of aluminum, in the potlining and represent toxic impurities which prevent a storage or reuse of the bulk material.

The impurities can, however, also contain sulfur and/or alkalis such as Na and Ka as well as non-ferrous metals such as Zn, for example.

Bulk material is advantageously used of which more than 50% by weight has a grain size of more than 30 mm, in particular more than 50% by weight has a grain size between 50 and 150 mm. With such grain sizes, it has been found within the framework of the invention that inductive fields couple very easily into the bulk material. Such high grain sizes furthermore have the advantage that complex, and thus energy-intensive and cost-intensive, grinding steps are not necessary, but rather relatively coarsely broken bulk material can be used.

In this respect, however, a fine fraction of less than 50 mm, in particular less than 30 mm, in particular less than 10 mm, remain in the bulk material. Even a fine fraction present as dust can remain in the bulk material. The fine fraction is indirectly heated through the coarse fraction. This makes a separation of the fine fraction and the coarse fraction of the bulk material before the carrying out of the method in accordance with the invention unnecessary.

The bulk material can be acquired by crushing molded parts and/or bricks using, for example, a conventional crusher. It can advantageously be a jaw crusher, a cone crusher, a rotary crusher or similar crusher. They are suitable to achieve desired coarse grain sizes and are easily available as conventionally used crushers.

In accordance with an aspect of the invention, bricks containing carbon to be crushed into bulk material are broken out of an SPL, a cathode block, a furnace lining or a similar installation situation before the crushing. A similar installation situation is understood in the sense of the invention as a substantially regular arrangement of bricks at a site of their use in which they satisfy their function, for instance high temperature resistance and containment of a smelt. The bricks thus do not have to be removed individually, but can rather be “dismantled” using conventional machines, for example, which are conventionally used, for instance, for building demolition. This allows an acquisition of the bulk material with a small effort and therefore low costs and in a short time frame.

The impurities can contain aluminum. In this respect, the aluminum can be present in metallic form, as an oxide, as a carbide and/or in another chemical compound. In particular in an electrolytic smelting of aluminum, a carbon lining or a cathode having aluminum as a metal or as a chemical compound is contaminated.

The impurities can contain iron. In this respect, the iron can be present in metallic form, as an oxide, as a carbide and/or in another chemical compound. In particular in steel acquisition or steel smelting processes, a carbon lining having iron as a metal or as a chemical compound is contaminated.

Induction fields having frequencies between 1 and 50 kHz, in particular between 1 and 10 kHz, in particular between 2 and 5 kHz, are advantageously generated. At these low frequencies, the induction fields couple particularly easily into coarse grains.

Maximum temperatures up to 2500° C. can be produced in the reactor. This is possible by the direct coupling of the induction fields into the bulk material.

Maximum temperatures between 1250 and 1800° C., in particular between 1300 and 1750° C., in particular between 1450 and 1700° C., are preferably set in the reactor. These temperatures are high enough that cyanides decompose under the effect of water vapor, which starts from approximately 700° C., and cyanides are cracked and AlF₃ is sublimated, which starts in each case from approximately 1300° C. In contrast, these temperatures are low enough that no silicon carbide, or at least hardly any silicon carbide, is formed, for the formation of SiC only starts from 1700° C. from a thermodynamic viewpoint.

In the method, at least some of the impurities can be dissolved in a present slag and/or in a slag forming in the process. This slag can be formed from the already present impurities with Al compounds and/or Fe compounds as the main components.

At least one slag former and/or one flux are advantageously added to the reactor. Slag formers facilitate the formation of a slag; fluxes lower its viscosity so that the slag can flow more easily and can take up impurities in so doing. Contaminants present on a surface of the bulk material can thus be washed off the bulk material by means of the slag.

In accordance with a possible embodiment of the invention, a compound containing calcium, such as CaO, CaCO₃ or dolomite, and/or a compound containing silicon, such as SiO₂ or a silicate, and/or a compound containing iron, such as an iron oxide or iron ore, is added to the reactor. They form a slag together with the optionally present aluminum compounds of the bulk material. In this respect, Si compounds can act as a flux, for example. In the event of the use of bulk material which does not come from aluminum production, a slag can also form in an absence of aluminum. The named added compounds can advantageously also be added as slag. Compounds containing iron ore, for example, suitable to bind sulfur present as an impurity as iron sulfide.

The slag can advantageously flow into a lower zone of the reactor where it accumulates and is removed from there. The method can thereby be carried out continuously. In this respect, the slag can be mixed with bulk material.

The slag can solidify at least partly in the lower zone. This occurs, for example, in that the lower zone is not inductively heated. A liquid portion of slag can nevertheless also be present in addition to the solidified slag in the lower zone.

The slag is removed from the lower zone. This can be carried out by means of a pusher and/or of a crusher. After the removal, the bulk material and the slag advantageously slide on into the lower zone.

Water and/or water vapor is/are preferably introduced in at least one zone of the reactor. This can take place by atomization or nebulization. In the following, water and/or water vapor is/are also only called water, which can naturally be present at the corresponding temperatures in gaseous form and/or vapor form.

The introduction of water can advantageously satisfy a plurality of functions. Chemical compounds can thus be decomposed hydrolytically and/or pyrohydrolytically. Cyanides can, for example, be decomposed pyrohydrolytically.

Furthermore, bulk material and/or loading materials can be introduced into the reactor in a damp state. The water thus introduced can likewise satisfy the above-described functions. Induction fields such as described for dry bulk material can couple into damp bulk material.

Furthermore, the slag and the bulk material containing carbon can be separated from one another by quenching with water. This can advantageously take place in the lower zone and/or in a lower region of a middle zone of the reactor where the slag smelt above all highly wets the bulk material in a low viscosity state. The slag and the bulk material are chilled fast by the contact with water, which results in mechanical strains which can effect a flaking of the slag from the bulk material. This has the advantage that slag and bulk material admittedly lie next to one another in a mixture taken from the reactor, but are already present separate from one another. The slag and the refined bulk material can be separated from one another by conventional processes, for example by flotation processes.

The slag and the then refined bulk material can be reused after the removal. The slag can be used as an additive in construction materials, such as cement, for example. It is advantageously milled for this purpose. The bulk material containing carbon can be used as fuel, for example. Alternatively, the bulk material containing carbon can be used as the material, for example, in wear resistant lining, for instance in gutters. This is possible in that the bulk material still has a very high strength after the process and has maintained its grain size. The carbon of the bulk material can naturally be used for all further applications in which conventional carbon is used which has not already been used industrially and subsequently refined.

In the method in accordance with the invention, at least some of the impurities are advantageously changed into a gas phase. This facilitates a removal of the impurities.

At least one of the following steps is carried out, for example:
pyrohydrolytic decomposition of compounds such as cyanides;
cracking compounds such as cyanides;
sublimating of compounds such as AlF₃;
smelting and vaporizing of compounds such as low alkali metals and non-ferrous metals and their compounds, in particular zinc and zinc compounds.

Impurities converted into a gaseous phase are advantageously washed out with a liquid, in particular water. A washing out of gaseous compounds advantageously takes place spatially separately from the reactor space, for example in a gas scrubber, such as a scrubber tower which is connected to the reactor space.

The object of the present invention is furthermore satisfied by the features of the reactor in accordance with claim 22. Advantageous further developments are set forth in the dependent claims 23 to 33.

The reactor has induction coils which are suitable to heat the bulk material inductively and directly.

The induction coils are advantageously suitable to set a predefined temperature gradient in the radial and/or axial direction of the reactor. A temperature gradient can be used directly to control the method in accordance with the invention.

The induction coils are advantageously suited to heat the bulk material without a temperature gradient or with a low temperature gradient. In particular a radial temperature gradient is possible which is smaller than 100 K/m, in particular smaller than 50 K/m, in particular smaller than 30 K/m.

The reactor advantageously has a high temperature resistant inner wall into which the induction fields generated by the induction coils at the frequencies used for heating the bulk material do not couple or at least hardly couple. This reduces the temperature load of the inner wall and considerably extends its life expectancy with respect to conventional heaters. The inner wall can have a lining which contains at least one material from the group consisting of carbon, oxidic refractory materials, non-oxidic refractory materials and chamotte.

The lining advantageously comprises clay-bound graphite. Despite the high carbon content, clay-bound graphite has such a low electric conductivity that it cannot be inductively heated.

The reactor advantageously has a reactor space which has an upper zone, a middle zone and a lower zone in the axial direction, with the reactor in particular being able to be designed such that bulk material to be refined can be introduced into the upper zone, such that the middle zone is provided with the induction coils extending at least partly around the reactor and such that slag and/or refined bulk material can accumulate in the lower zone and can be removed from it. A continuous process can thus be carried out with the reactor.

The reactor advantageously has a diameter of more than 50 cm in the region of the induction coils to achieve a throughput which is as high as possible. The diameter is advantageously larger than 1 m, in particular 1 m up to 1.5 m. Such a large reactor in conjunction with the direct inductive heating in accordance with the invention allows high throughput quantities. The bulk material is heated considerably faster by the process of inductive heating in conjunction with low frequencies and coarse grain size of the bulk material than by conventional heating, which allows an energy-efficient and cost-efficient refining.

The reactor can expand conically downwardly in the lower zone and/or in a lower region of the middle zone. This facilitates a downward sliding of bulk material and slag.

The reactor advantageously has a loading lock such as a cell wheel lock via which the reactor can be supplied with bulk material, with the loading lock being suitable to prevent an uncontrolled escape of gases from the reactor. Bulk material and loading materials and further optionally required substances can thus be added to the reactor space without gases escaping in an uncontrolled manner.

Furthermore, a gas scrubber connected to the reactor space, such as a scrubber tower, can be provided which is suitable to scrub impurities converted into a gaseous phase using a liquid such as water. Gaseous toxic compounds from the gas phase can be bound by liquid in the gas scrubber and can condense in the gas scrubber due to a low temperature. Large-volume gas quantities can be reduced to smaller liquid quantities in this process. Further processes, in particular chemical processes, can run in the gas scrubber. Zinc present in a gaseous compound can thus be oxidized to zinc oxide by water vapor and can subsequently be filtered off.

At least one injection apparatus can advantageously be provided in the reactor which is suitable to introduce water and/or water vapor into the reactor space in at least one of the upper, middle and lower zones. Water can thereby be brought directly to the impurities so that the above-described reactions run faster.

At least one induction coil is advantageously cooled. Since the induction fields do not couple into the reactor wall, the latter is not heated directly and therefore does not have to be actively coupled. The reactor wall is, however, advantageously cooled by convection.

Further advantageous aspects and further developments of the invention will be explained in the following with reference to a preferred embodiment and to an associated FIGURE.

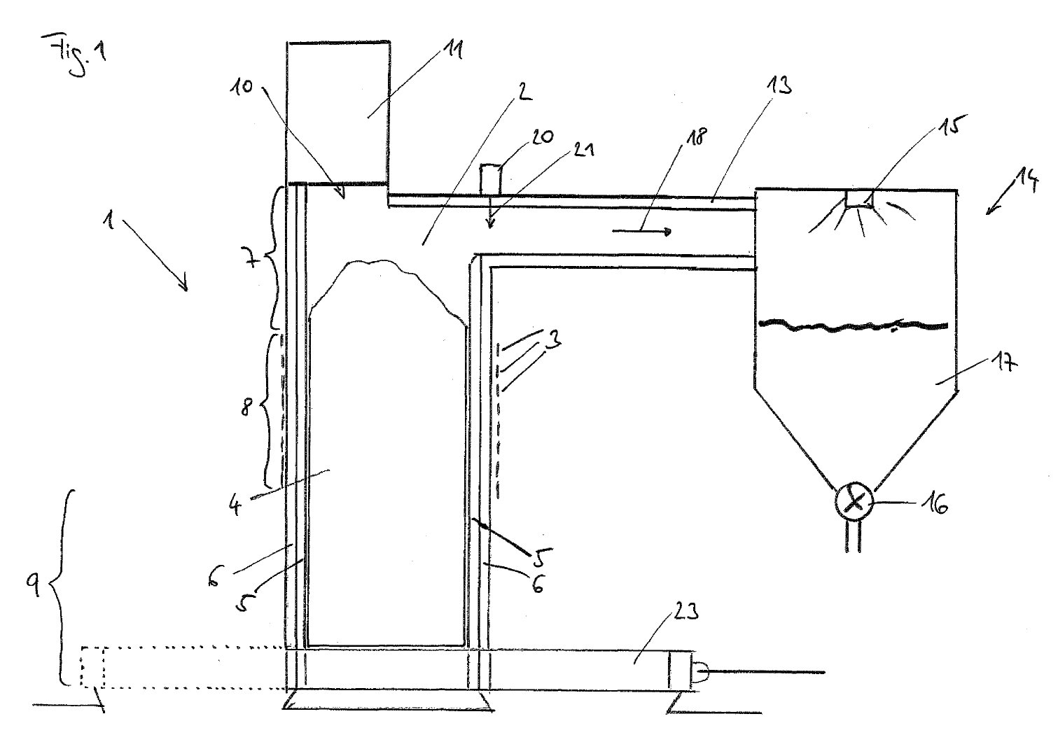

In this respect, FIG. 1 shows a schematic representation of a reactor in accordance with the invention.

A reactor 1 in accordance with the invention has a reactor space 2 having a diameter of 1.5 m around which induction coils 3 are arranged which at least partly surround the reactor space 2 and which are suitable to heat a bulk material 4 containing carbon present in the reactor space 2 to temperatures of up to 1800° C. at frequencies between 1 and 50 kHz. The reactor space 2 is surrounded by a high temperature resistant lining 5 of a reactor wall 6. In this embodiment, the lining 5 comprises refractory bricks. However, all other high temperature resistant materials are suitable into which a field generated by the induction coils 3 does not couple, such as clay-bound carbon. The reactor 1 has an upper zone 7, a middle zone 8 and a lower zone 9.

A filler opening 10 is provided at the upper zone 7 via which the bulk material 4, slag formers, flux formers and similar can be input into the reactor space 2. To prevent an escape of gases from the reactor space 2, a cell wheel lock is placed onto the filler opening 10 as a loading lock 11.

The induction coils 3 are provided in the middle zone 8. A pusher 23 is provided in the lower zone 9 which acts as a crusher for crushing slag and bulk material 4 for their removal.

The upper zone 7 is provided with a connection piece 13 which connects the reactor space 2 to a scrubber tower 14 which acts as a gas scrubber 14. At least one water nozzle 15 is provided in the scrubber tower 14 to inject water into the scrubber tower 14. Collected water 17 can be let out via a valve 16.

Bulk material 4 together with, for example, slag from the furnace can be filled into the reactor space 2 as slag former and flux via the cell wheel lock 11 to operate the reactor 1. Slag formers and flux can also be added as individual components. The bulk material 4 in this example is cathode breakage from a cell for the electrolytic smelting of 1. The bulk material 4 is contaminated, in addition to chamotte which had entered into the bulk material on the breaking of the cathodes out of the cell for the electrolytic smelting of, by metallic aluminum and aluminum compounds, with sodium cyanide and soluble fluorine compounds.

The induction coils 3 heat the contaminated bulk material 4 inductively and directly in that the induction fields couple directly into the cathode breakage. The slag former and the flux are also heated via the heated bulk material 4. A liquid slag arises in the middle zone 8 and the aluminum impurities also melt into it. The viscosity of the slag is lowered by the flux so that the slag flows into the lower zone of the reactor 1. The slag in this respect also transports off the chamotte. The slag cools down in the lower zone 9, that is outside an effective region of the induction coils 3. In this example, the slag is additionally cooled and solidified by the water cooling 12.

The cyanide and the fluorine compounds are calcinated from the bulk material 4 and move into the gas phase, or decompose, due to the temperature of 1750° C. in the middle zone in this example. The gaseous contaminants move via the connection piece 13 into the scrubber tower 14 due to the volume expansion and convection. Cyanides and fluorine compounds are dissolved by water trickling down from the water nozzle 15 and other gaseous compounds are condensed. A volume reduction thereby takes place which assists a gas flow from the reactor 2 into the scrubber tower 14 which is shown by an arrow 18 in FIG. 1.

Water vapor 21 is injected into the reactor space 2 into the upper zone 7 via a nozzle 20. The water vapor 21 already effects pyrohydrolysis of the cyanides present in the reactor space 2 from approximately 700° C. onward. In particular carbon monoxide, nitrogen and hydrogen arise in this process. Furthermore, the water vapor 21 results in a quenching of the slag in the lower zone, whereby it is blasted off the bulk material 4. The brittle slag 23 is crushed via the pusher 23 and is removed from the lower zone 9.

Slag and refined bulk material can subsequently be separated from one another using conventional separation processes due to their density difference. The refined bulk material containing carbon can be used, for example, as an additive for construction materials such as cement. The carbon of the bulk material can be used as fuel or for a utilization in wear resistant lining such as in gutters, for example. Washed out fluorine compounds in the water 17 of the scrubber tower 14 which is removed via the valve 16 can likewise be reused, for example by returning into an aluminum electrolysis for setting there ratio of NaF to AlF₃ in the smelt.

In a further example, the method in accordance with the invention is simulated in a miniature setup (not shown). In this respect, a clay-bound graphite crucible with a diameter of 150 mm and a height of 200 mm was used as the reactor. An induction coil which is operated at 4 kHz heats crushed material of an amorphous carbon cathode having an anthracite fraction of approximately 60% by weight as the bulk material. The bulk material was heated to 1600° C. in 45 min. The arising exhaust gases were extracted and condensed in a filter unit using mineral wool fibers. The fluorine content and cyanide content before and after the heating of the bulk material was analyzed in a wet chemical manner and by X-ray fluorescence analysis. The bulk material was equally analyzed before and after the heating. A start of the vaporization of impurities was observed at approximately 700° C. Furthermore, a calcination of NaF, NaCN, Al₂O₃ and AlF₃ from the carbon is determined, with these compounds being on the surfaces of the bulk material. If CaO and SiO₂ were additionally added to the bulk material, a slag formed which took up these compounds and collected at the base of the crucible. An eluate of the bulk material contained more than 1 mg/l cyanide before the heating; less than 0.01 mg/l afterward.

The efficiency of the method and of the reactor in accordance with the invention is thus clearly demonstrated.

All the features named in the description, in the examples and in the claims can contribute to the invention in any desired combination. The slag forming components can in particular originate both from the contaminants and from the added slag former. Depending on the provenience of the bricks containing carbon and thus of the impurities, they no longer have to be added as slag former on the presence of slag forming components as impurities. A refining can also be carried out without slag formation.

1.-35. (canceled)

36. A method for refining bulk material containing impurities and carbon, the method comprising the step of inductively and directly heating the bulk material in a reactor.

37. A method in accordance with claim 36, wherein the bulk material contains at least one bulk material from the group consisting of broken cathodes from an aluminum smelting process, broken anodes, broken carbon linings from a steel smelting furnace, from a steel furnace or from another metal smelting furnace, from a glass smelting furnace, from a ceramic smelting furnace and from other bricks containing carbon to be refined.

38. A method in accordance with claim 36, wherein the impurities contain at least one impurity from the group consisting of cyanides, sulfur, soluble fluorides, and alkali metals and non-ferrous metals.

39. A method in accordance with claim 36, wherein bulk material is used of which more than 50% by weight has a grain size of more than 30 mm.

40. A method in accordance with claim 36, wherein the impurities contain aluminum in metallic form, as an oxide, as a carbide and/or in another chemical compound.

41. A method in accordance with claim 36, wherein the impurities contain iron in metallic form, as an oxide, as a carbide and/or in another chemical compound.

42. A method in accordance with claim 36, wherein the step of heating is carried out inductively at frequencies between 1 and 50 kHz.

43. A method in accordance with claim 36, wherein maximum temperatures of up to 2500° C. are set in the reactor.

44. A method in accordance with claim 36, wherein a slag former is added in the reactor.

45. A method in accordance with claim 36, wherein a flux is added in the reactor.

46. A method in accordance with claim 36, wherein a compound containing calcium such as CaO, CaCO₃ or dolomite and/or a compound containing silicon such as SiO₂ or a silicate and/or a compound containing iron such as iron oxide or iron ore is/are added to the reactor.

47. A method in accordance with claim 36, wherein water and/or water vapor is introduced in at least one zone of the reactor.

48. A method in accordance with claim 47, wherein atomized or nebulized water and/or water vapor is introduced in at least one zone of the reactor.

49. A method in accordance with claim 36, further comprising at least one of the steps of:
pyrohydrolytic decomposing of compounds such as cyanides;
cracking compounds such as cyanides;
sublimating of compounds such as AlF₃,
smelting and vaporizing metals and/or compounds such as reduced alkali metals and non-ferrous metals and/or their compounds, in particular zinc and zinc compounds, is carried out.

50. A reactor for carrying out a method for refining bulk material containing impurities and carbon, the method comprising the step of inductively and directly heating the bulk material in a reactor, wherein the reactor has induction coils which are suitable to heat the bulk material inductively.

51. A reactor in accordance with claim 50, wherein the induction coils are suitable to set a predefined temperature gradient in the radial and/or axial direction of the reactor.

52. A reactor in accordance with claim 50, wherein the reactor has a high temperature resistant inner wall into which the induction fields generated by the induction coils at the frequencies used for heating the bulk material do not couple or do at least hardly couple.

53. A reactor in accordance with claim 50, wherein the reactor has a reactor space which has an upper zone, a middle zone and a lower zone in the axial direction, with the reactor being designed such that bulk material to be refined can be introduced into the upper zone, such that the middle zone is provided with the induction coils extending at least partly around the reactor and such that slag and/or refined bulk material can accumulate in the lower zone and can be removed from it.

54. A reactor in accordance with claim 50, wherein the reactor has a loading lock such as a cell wheel lock, via which the reactor can be supplied with bulk material, with the loading lock being suitable to prevent an uncontrolled escape of gases from the reactor.

55. A reactor in accordance with claim 50, wherein at least one injection apparatus is provided which is suitable to introduce water and/or water vapor into the reactor space in at least one of the upper, middle and lower zones.
